(19) United States
(12) Patent Application Publication
(10) Pub. No.: US 2021/0180539 A1
(43) Pub. Date: Jun. 17, 2021

(54) PISTON FOR INTERNAL COMBUSTION ENGINE

(71) Applicant: ART METAL MFG. CO., LTD., Ueda-shi (JP)

(72) Inventors: Takuya NOGUCHI, Ueda-shi (JP); Yukihiro KIKUCHI, Ueda-shi (JP)

(73) Assignee: ART METAL MFG. CO., LTD., Ueda-shi (JP)

(21) Appl. No.: 16/074,244

(22) PCT Filed: Feb. 16, 2017
(86) PCT No.: PCT/JP2017/005651

§ 371 Date: Jul. 31, 2018

(30) Foreign Application Priority Data
Feb. 16, 2016 (JP) 2016-027144

(51) Int. Cl. F02F 3/22

(52) U.S. Cl. CPC F02F 3/22; F16J 1/09

(57) ABSTRACT

To provide a piston for an internal combustion engine configured to ensure a required amount of cooling oil to be effectively guided to portions that need to be cooled and to achieve a lightweight structure. A piston 3 comprises a piston crown portion 24 including a top portion 21 and a pair of pin boss portions each having a piston pin hole to allow insertion of a piston pin and configures to be cooled by a cooling oil injected from an oil jet apparatus having a nozzle toward a back surface 30a of the top portion 21. The top portion 21 comprises cooling voids 29a, 29b provided near at least one of the pin boss portions inside the top portion 21 and inlet openings 35a, 35b provided on the back surface 30a and configured to guide the oil injected from the nozzle toward the cooling voids 29a and 29b.

### TECHNICAL FIELD

The present invention relates to a piston for an internal combustion engine configured to effectively cool a piston by injecting a cooling oil from an oil jet apparatus to a back surface of a top portion of the piston.

### BACKGROUND ART

In the related art, known examples of a piston for an internal combustion engine such as an engine include a configuration having: a piston crown portion including a top portion being subjected to an explosive gas pressure of combustion gas and a land portion having a piston ring groove on the periphery; a pair of pin boss portions coupled to a smaller end portion of a connecting rod via a piston pin; and a pair of skirt portions configured to guide a vertical reciprocal motion of the piston. The top portion of the piston crown portion is inevitably subjected to a high-temperature combustion gas, and thus an increase in temperature of the piston in association with an increase in output of the engine is now an issue. In particular, there is a problem in that high temperature of the piston in an axial direction of front and rear sides (near the pin boss portion of the piston crown portion) may cause a problem such as aluminum adhesion in the piston ring grooves.

In Patent Literature 1, therefore, a piston structure having an annular oil channel in an interior of a piston (hereinafter, referred to as a cooling channel) provided for cooling the piston is known. The cooling channel is provided with an oil inlet port and an oil outlet port. The piston is cooled from the interior by an oil supplied from the oil inlet port into the cooling channel. However, as a boss cooling channel that communicates with the oil channel is provided in a pin boss portion, a sufficient thickness for forming the cooling channel is required. Therefore, the piston structure in Patent Literature 1 has a difficulty in achieving a lightweight structure of the piston simultaneously and is complex in shape and costly.

For example, in Patent Literature 2, a piston is proposed in which an oil guiding channel is formed to extend between a pair of skirt portions on a back surface of a piston top portion, an oil injected from an oil jet apparatus toward one end side of the oil guiding channel is guided toward the other end side of the oil guiding channel, and thickened portions configured to restrict a flow of the oil flowing toward side wall portions that connect the pair of skirt portions to each other are formed along both sides of the oil guiding channel. However, such a piston can hardly guide a required amount of injected oil to portions that require to be cooled by the guiding channel, and thus does not necessarily provide satisfactory cooling efficiency.

### CITATION LIST

### Patent Literature

PTL 1: JP-A-2009-520901

PTL 2: JP-A-2009-191779

### SUMMARY OF INVENTION

### Technical Problem

Accordingly, it is an object of the present invention to provide a piston for an internal combustion engine configured to ensure a required amount of cooling oil to be effectively guided to portions that need to be cooled and to achieve a lightweight structure.

### Solution to Problem

A piston for an internal combustion engine of the present invention has been made to solve such problems, the piston for an internal combustion engine comprises a piston crown portion including a top portion and a pair of pin boss portions each having a piston pin hole to allow insertion of a piston pin and configured to be cooled by a cooling oil injected from an oil jet apparatus having a nozzle toward aback surface of the top portion. The top portion comprises a cooling void provided near at least one of the pin boss portions inside the top portion, and an inlet opening provided on the back surface of the top portion and configured to guide the oil injected from the nozzle toward the cooling void.

In the piston for an internal combustion engine of the present invention, one each of the cooling voids may be provided near both of the pin boss portions.

Also, in the piston for an internal combustion engine of the present invention, the top portion may include a terminal end at one end of the cooling void, and the inlet opening and the terminal end may be provided at ends of each of the cooling voids.

Also, in the piston for an internal combustion engine of the present invention, the top portion may include an outlet opening provided in the back surface and configured to let the oil flowed into the cooling void through the inlet opening to be drained, and the inlet opening and the outlet opening are provided respectively at the ends of each of the cooling voids.

Also, in the piston for an internal combustion engine of the present invention, the top portion may comprise a side surface opening provided in the back surface and configured to let the oil flowed into the cooling void through the inlet opening be drained from outside of the pin boss portion or the side wall portion.

Also, in the piston for an internal combustion engine of the present invention, the top portion may comprise a groove provided on the back surface and configured to guide the oil injected from the nozzle to the inlet opening.

Also, in the piston for an internal combustion engine of the present invention, the top portion may comprise a projection at a position in the back surface where the oil injected from the nozzle hits, and the projection may comprise an inclined surface that is lowered toward the inlet opening to guide the hit oil into the cooling void.

Also, in the piston for an internal combustion engine of the present invention, the inclined surface may be inclined to guide the oil to the back surface between the pin boss portions.

Also, in the piston for an internal combustion engine of the present invention, the nozzle may be arranged near the inlet opening.

Also, in the piston for an internal combustion engine of the present invention, the cooling void may have an inner diameter increasing as it goes away from the inlet opening.

Also, in the piston for an internal combustion engine of the present invention, the piston may be a piston for a gasoline engine.

### Advantageous Effects of Invention

According to the present invention, the piston can be efficiently cooled to reduce thermal load that the piston bears, and can achieve the lightweight structure of the piston while ensuring the strength of the piston.

### BRIEF DESCRIPTION OF DRAWINGS

FIG. 1 is a cross-sectional view illustrating a principal portion of an internal combustion engine that a piston of the present invention is applied to.

FIG. 2 is a perspective view of the piston of a first embodiment of the present invention viewed from a back surface.

FIG. 3 is a lateral cross-sectional view of the piston taken along the line III-III in FIG. 4.

FIG. 4 is a vertical cross-sectional view of the piston taken along a direction orthogonal to an axial direction of a piston hole.

FIG. 5 is a perspective view illustrating a lateral cross section of the piston taken along the line V-V in FIG. 4.

FIG. 6 is a lateral cross-sectional view of a piston according to a second embodiment of the present invention.

FIG. 7 is a lateral cross-sectional view illustrating a modified example of a piston.

FIG. 8 is a vertical cross-sectional view of the modified example of the piston taken along a direction orthogonal to an axial direction of a piston hole.

### DESCRIPTION OF EMBODIMENTS

Referring now to attached drawings, a first embodiment and a second embodiment of the present invention will be described. However, the present invention is not limited to the illustrated embodiments. For example, the piston of the present invention is applied to the piston used for a gasoline engine in the description, but may be applied to any engine such as diesel engines, LPG engines, methanol engines, hydrogen engines, etc.

### First Embodiment

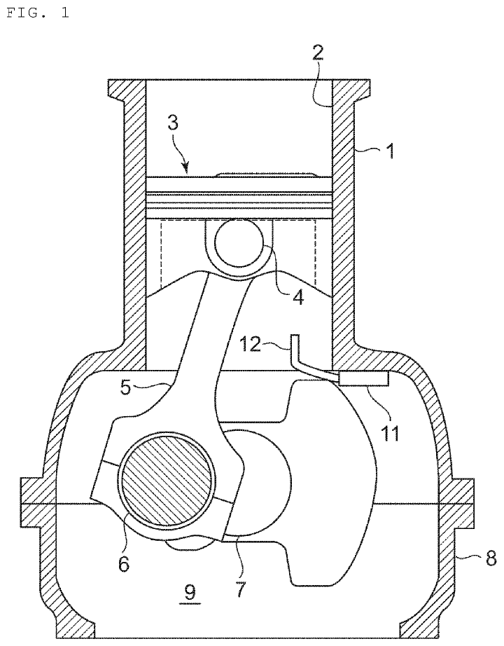

FIG. 1 is a cross-sectional view illustrating a principal portion of an internal combustion engine that a piston of the present invention is applied to. A piston 3 is a piston applied to a gasoline engine. The internal combustion engine includes a cylinder block 1, a cylindrical cylinder bore 2 formed in the cylinder block 1, and the piston 3 slidably accommodated inside the cylinder bore 2. An upper end of a connecting rod 5 is coupled to the piston 3 via a piston pin 4. A lower end of the connecting rod 5 is coupled to a crankshaft 7 via a crank pin 6.

A crank case 8 provided below the cylinder block 1 in the drawing and a lower portion of the cylinder block 1 define a crank chamber 9 in which the crankshaft 7 is accommodated. An oil jet apparatus 11 configured to inject an oil for cooling the piston 3 is provided on a portion near a lower end of the cylinder bore 2, which is on the crank chamber 9 side. The oil jet apparatus 11 includes a nozzle 12 having a distal end directed upward to inject oil from below in the drawing toward the piston 3.

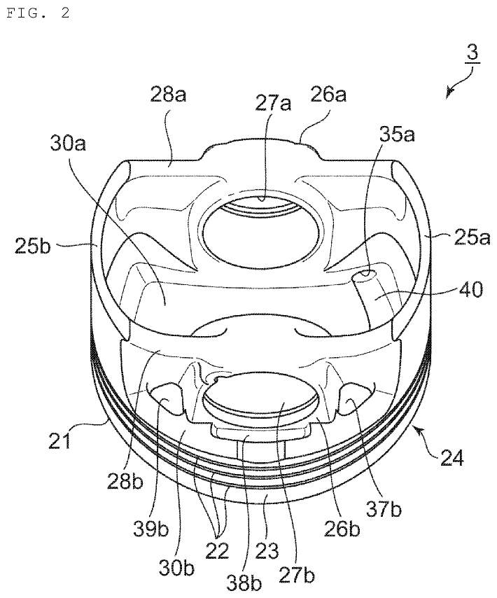

FIG. 2 is a perspective view of the piston 3 of the first embodiment of the present invention viewed from a back surface.

The piston 3 includes a piston crown portion 24, a pair of skirt portions 25a and 25b, a pair of pin boss portions 26a and 26b, and side wall portions 28a and 28b.

The piston crown portion 24 includes a top portion 21 and a land portion 23 having piston ring grooves 22. The piston crown portion 24 includes cooling voids 29 described later. The skirt portions 25a and 25b (hereinafter, referred to simply as skirt portions 25 unless otherwise specifically discriminated, the same applies hereinafter) extend upright from an outer peripheral edge of the piston crown portion 24. The pin boss portions 26a and 26b (pin boss portions 26) are provided on a back surface side of the top portion 21 with the direction of the plane substantially orthogonal to the skirt portions 25a and 25b. Hereinafter, the back surface of the top portion 21 located in a space defined by the skirt portions 25 and the side wall portions 28 is referred to as “back surface 30a”, and the back surface of the top portion 21 located outside the above-described space is referred to as “back surface 30b”. The pin boss portions 26a and 26b include piston pin holes 27a and 27b (piston pin holes 27) that allow insertion of the piston pin 4. The side wall portions 28a and 28b (side wall portions 28) extend in a direction intersecting a direction of center axis of the piston pin holes 27a and 27b (piston pin 4), and couple ends of the pin boss portions 26a and 26b and the skirt portions 25a and 25b.

The cooling voids 29 provided in the piston crown portion 24 will now be described.

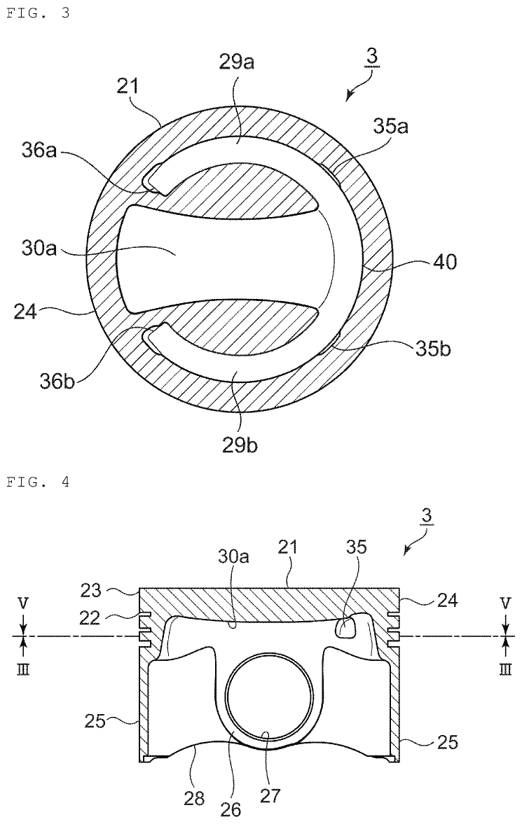

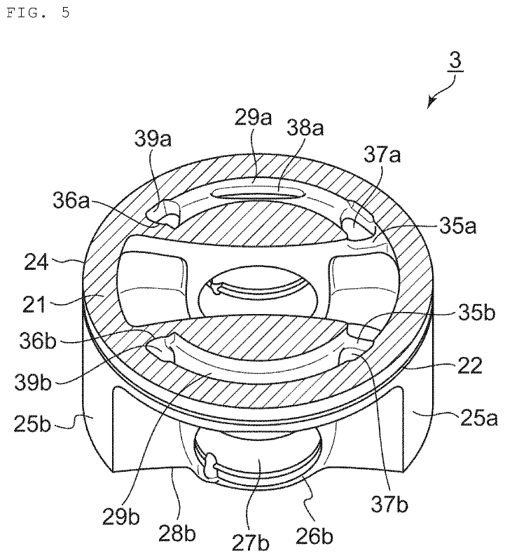

FIG. 3 is a lateral cross-sectional view of the piston 3 taken along the line III-III in FIG. 4. FIG. 4 is a vertical cross-sectional view of the piston 3 taken along a direction orthogonal to an axial direction of the piston pin holes 27. FIG. 5 is a perspective view illustrating a lateral cross section of the piston 3 taken along the line V-V in FIG. 4.

Cooling voids 29a and 29b (cooling voids 29) are an arcuate-shaped voids formed inside the top portion 21 along the outer peripheral edge of the piston crown portion 24. The cooling voids 29 are provided near both of the pin boss portions 26 (and the side wall portions 28). The cooling voids 29 are formed between the skirt portions 25 (portions where the skirt portions 25a and 25b are not formed) to surround outer peripheries of the pin boss portions 26. The cooling voids 29 are formed by using preferably a salt core, but not limited thereto.

In the first embodiment, two cooling voids 29a and 29b are provided along the pin boss portions 26a, and 26b, but providing only one of the cooling voids 29a and 29b is also applicable.

The piston crown portion 24 (top portion 21) includes, on the back surface 30a thereof, inlet openings 35a and 35b, terminal ends 36a and 36b, first to third side surface openings 37a to 39a and 37b to 39b, and a groove 40.

The inlet openings 35a and 35b (the inlet openings 35) guide an oil to be injected from the nozzle 12 of the oil jet apparatus 11 and let the oil flow into the cooling voids 29. The inlet openings 35 are provided on the back surface 30a of the top portion 21. Each of the inlet openings 35 corresponds to each ends of the cooling voids 29, and is provided inside each of the side wall portions 28. The inlet openings 35a and 35b are preferably disposed at symmetrical positions with respect to a position where the oil injected from the nozzle 12 hits. The terminal ends 36a and 36b (terminal ends 36) correspond to the other ends of the cooling voids 29 and are provided inside the side wall portions 28.

Inner diameters of the cooling voids 29 increase from the inlet openings 35 toward the terminal ends 36. Specifically, the cooling voids 29 are formed to increase in inner diameter toward a front surface side of the top portion 21 (to incline toward the front surface side of the top portion 21). The increase in diameters of the cooling voids 29 provides oil-flowing surfaces with gradients. This inclination achieves a smooth flow of the oil entirely in the cooling voids 29. This inclination makes as much oil flow into the cooling voids 29 as possible to make the piston 3 effectively cooled.

The first to third side surface openings 37a to 39a and 37b to 39b (first to third side surface openings 37 to 39) let the oil flowed from the inlet openings 35 into the respective cooling voids 29 drained to outside the pin boss portions 26 or the side wall portions 28. The first to third side surface openings 37 to 39 are provided in the back surface 30b.

The first side surface openings 37 are provided near the side wall portions 28 on the inlet openings 35 side. The second side surface openings 38 are provided near the pin boss portions 26. The third side surface openings 39 are provided near the side wall portions 28 on the terminal ends 36 side. The groove 40 is provided in the back surface 30a, and guides the oil injected form the nozzle 12 to the respective inlet openings 35. Both ends of the groove 40 are connected to the inlet opening 35a and the inlet opening 35b, respectively.

Subsequently, an operation of the piston 3 of the first embodiment will be described.

The oil jet apparatus 11 injects a cooling oil from the nozzle 12 toward a substantially center (the back surface 30a of the top portion 21) of the groove 40 in the longitudinal direction. The oil is injected substantially toward the center as described above in design but may actually be deviated toward one of the inlet openings 35. The oil hit on the groove 40 is guided by the groove 40, bifurcates to the inlet openings 35, and flows into the cooling voids 29. The oil overflowed from the groove 40 passes over the back surface 30a from the skirt portion 25a side to the skirt portion 25b side to cool the top portion 21 down.

The oil flowed into the cooling voids 29 runs along the cooling voids 29 while receiving an inertia force generated by a sliding action of the piston, and efficiently cools over a range from the interior of the piston crown portion 24 to peripheries of the pin boss portions 26. Part of the oil flows to the terminal ends 36. The oil flowed to the terminal ends 36 and remaining oil are drained out from the first to third side surface openings 37 to 39 and the inlet openings 35. Part of the oil drained from the first and third side surface openings 37 and 39 flows along the side wall portions 28 and side walls of the pin boss portions 26 and cools these parts. Part of the oil drained from the second side surface opening 38 flows near the peripheral edge of the piston pin holes 27 and cools these parts.

The piston 3 of the first embodiment configured in this manner, being provided with the cooling voids 29 in the piston crown portion 24, achieves efficient cooling of the periphery of the pin boss portion 26. In addition, the cooling voids 29 cool a portion near the piston ring groove 22 efficiently, aluminum adhesion in the piston ring groove 22 may be inhibited. The piston 3 of the first embodiment configured in this manner may prevent problems that may occur on the piston 3 in association with improvement of the cooling efficiency and thus may achieve an improvement of engine performances.

Even a piston for gasoline engines normally having a thinner piston crown portion 24 (land portion 23) than the piston for diesel engines may achieve a lightweight structure with required strength maintained during use with the cooling voids 29 arranged with a high spatial efficiency. In addition, the piston 3 includes three openings; the first to third side surface openings 37 to 39 and thus significant weight reduction is achieved.

The piston crown portion 24 may include one, two, three or more side surface openings. The piston crown portion 24 may not have the side surface openings 37 to 39. In this case, the oil entered through the inlet openings 35 is cooled in the cooling voids 29 and then is drained from the inlet openings 35. However, considering the oil cooling effect, the side surface openings or an outlet openings 61 described later are preferably provided.

### Second Embodiment

A piston for an internal combustion engine according to a second embodiment of the present invention will be described.

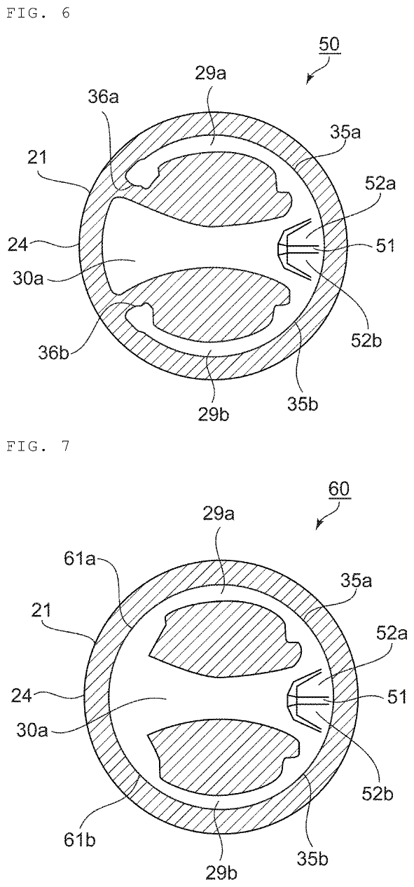

FIG. 6 is a lateral cross-sectional view of a piston 50 according to the second embodiment of the present invention and is a drawing corresponding to FIG. 3. The piston 50 of the second embodiment is different from the piston 3 of the first embodiment in that a projection 51 is provided on the back surface 30a of the top portion 21 instead of the groove 40. Other configurations of the piston 50 are substantially the same as the piston 3 of the first embodiment, and thus the configurations and parts corresponding to the first embodiment are designated by the same reference signs and overlapped description will be omitted.

The top portion 21 of the piston crown portion 24 includes the projection 51 provided on the back surface 30a at a position where the oil injected from the nozzle 12 of the oil jet apparatus 11 hits. The projection 51 is the highest substantially at the center between the inlet openings 35a and 35b and includes inclined surfaces 52a and 52b (inclined surfaces 52) decreasing in height toward the inlet openings 35a and 35b to guide the hit oil toward the cooling voids 29. The inclined surfaces 52 incline to be lowered from the skirt portion 25a side toward the skirt portion 25b to guide the oil to the back surface 30a between the pin boss portions 26.

An action of the piston 50 of the second embodiment will be described below. Note that only points different from the first embodiment will be described while omitting the overlapped description.

The oil jet apparatus 11 injects oil from the nozzle 12 toward the projection 51. The oil is guided by the inclined surfaces 52 of the projection 51, bifurcates to the inlet openings 35, and flows into the cooling voids 29. The oil flowed therein runs along the cooling voids 29 while receiving an inertia force generated by a sliding action of the piston, and efficiently cools over a range from the interior of the piston crown portion 24 to the peripheries of the pin boss portion 26. The oil flows toward the back surface 30a between the pin boss portion 26 by being guided by the inclined surfaces 52 to cool the entire top portion 21.

The piston 50 of the second embodiment configured in this manner is allowed to guide the oil suitably into the cooling voids 29 by the inclined surfaces 52 of the projection 51. The inclined surfaces 52 are further inclined toward the skirt portion 25b, and thus cooling of the back surface 30a between the pin boss portion 26 is also ensured.

Although several embodiments of the present invention has been described, these embodiments are intended for illustration only, and are not intended to limit the scope of the invention. These new embodiments may be implemented in other various modes, and various omissions, replacements, and modifications may be made without departing from the gist of the invention. These embodiments and modifications thereof are included in the scope and gist of the disclosure, and are included in the invention described in Claims and a range equivalent thereto.

For example, the pistons 3 and 50 of the first and second embodiments may have outlet openings 61a and 61b instead of the terminal ends 36 of the cooling voids 29.

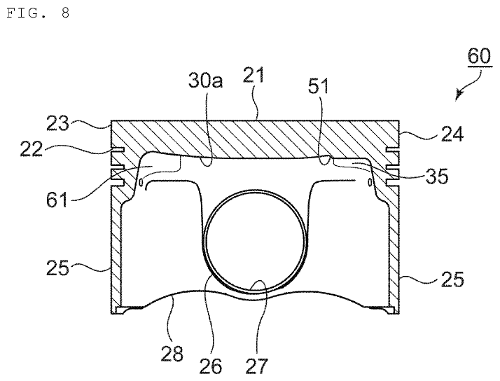

FIG. 7 is a lateral cross-sectional view illustrating a modified example of a piston 60, and is a drawing corresponding to FIG. 3 and FIG. 6. FIG. 8 is a vertical cross section of the piston 60 extending along the direction orthogonal to the axial direction of the piston pin holes 27.

The piston 60 will be described as a modification of the piston 50 of the second embodiment as an example. Configurations and parts corresponding to the pistons and 50 of the first and second embodiments are designated by the same reference signs and overlapped description will be omitted.

The outlet openings 61a and 61b (the outlet openings 61) let the oil flowed from the inlet openings 35 into the cooling voids 29 be drained. The outlet openings 61 are provided at positions symmetrical to the inlet openings 35 with respect to an axial direction of the piston pin 4. In other words, the outlet openings 61 are provided at the other ends of the cooling voids 29 inside the side wall portions 28. When the outlet openings 61 are provided, the first to third side surface openings 37 to 39 may be omitted.

The shape of the cooling voids 29 is not limited to the arcuate shape, and shapes which can effectively cool the piston mainly around the pin boss portion 26 may be employed.

In addition, the inlet openings 35 may be provided either on the thrust side or on the counter-thrust side.

### REFERENCE SIGNS LIST

1 cylinder block

2 cylinder bore

3,50,60 piston

4 piston pin

5 connecting rod

6 crank pin

7 crankshaft

8 crank case

9 crank chamber

11 oil jet apparatus

12 nozzle

21 top portion

22 piston ring groove

23 land portion

24 piston crown portion

25a, 25b (25) skirt portion

26a, 26b (26) pin boss portion

27a, 27b (27) piston pin hole

28a, 28b (28) side wall portion

29a, 29b (29) cooling void

30a, 30b back surface

35a, 35b (35) inlet opening

36a, 36b (36) terminal end

37a to 39a, 37b to 39b (37 to 39) first to third side surface opening

40 groove

51 projection

52a, 52b (52) inclined surface

61a, 61b (61) outlet opening

1. A piston for an internal combustion engine comprising a piston crown portion including a top portion and a pair of pin boss portions each having a piston pin hole to allow insertion of a piston pin and configured to be cooled by a cooling oil injected from an oil jet apparatus having a nozzle toward a back surface of the top portion, wherein the top portion comprises:
a cooling void provided near at least one of the pin boss portions inside the top portion; and
an inlet opening provided on the back surface of the top portion and configured to guide the oil injected from the nozzle toward the cooling void.

2. The piston for an internal combustion engine according to claim 1, wherein one each of the cooling voids is provided near both of the pin boss portions.

3. The piston for an internal combustion engine according to claim 1, wherein the top portion includes a terminal end at one end of the cooling void, and the inlet opening and the terminal end are provided at ends of each of the cooling voids.

4. The piston for an internal combustion engine according to claim 1, wherein the top portion includes an outlet opening provided in the back surface and configured to let the oil flowed into the cooling void through the inlet opening to be drained, and the inlet opening and the outlet opening are provided respectively at the ends of each of the cooling voids.

5. The piston for an internal combustion engine according to claim 1, wherein the top portion comprises a side surface opening provided in the back surface and configured to let the oil flowed into the cooling void through the inlet opening be drained from outside of the pin boss portion or the side wall portion.

6. The piston for an internal combustion engine according to claim 1, wherein the top portion comprises a groove provided on the back surface and configured to guide the oil injected from the nozzle to the inlet opening.

7. The piston for an internal combustion engine according to claim 1, wherein the top portion comprises a projection at a position in the back surface where the oil injected from the nozzle hits, and wherein the projection comprises an inclined surface that is lowered toward the inlet opening to guide the hit oil into the cooling void.

8. The piston for an internal combustion engine according to claim 7, wherein the inclined surface is inclined to guide the oil to the back surface between the pin boss portions.

9. The piston for an internal combustion engine according to claim 1, wherein the nozzle is arranged near the inlet opening.

10. The piston for an internal combustion engine according to claim 1, wherein the cooling void has an inner diameter increasing as it goes away from the inlet opening.

11. The piston for an internal combustion engine according to claim 1, wherein the piston is a piston for a gasoline engine.
